(19) United States
(12) Patent Application Publication
(10) Pub. No.: US 2025/0277758 A1
(43) Pub. Date: Sep. 4, 2025

(54) METHOD AND SYSTEM FOR FULL-FIELD QUANTITATIVE X-RAY PHASE NANOTOMOGRAPHY USING SPACE-DOMAIN KRAMERS-KRONIG RELATION

(71) Applicants: TOMOCUBE, INC., Daejeon (KR); KOREA ADVANCED INSTITUTE OF SCIENCE AND TECHNOLOGY, Daejeon (KR)

(72) Inventors: YongKeun PARK, Daejeon (KR); KyeoReh LEE, Daejeon (KR)

(21) Appl. No.: 19/063,353

(22) Filed: Feb. 26, 2025

(30) Foreign Application Priority Data
Feb. 29, 2024 (KR) 10-2024-0030088

(51) Int. Cl. G01N 23/046

(52) U.S. Cl. CPC G01N 23/046; G01N 2223/1016; G01N 2223/345; G01N 2223/419

(57) ABSTRACT

The present disclosure relates to a method and a system for full-field quantitative X-ray phase nanotomography using a space-domain Kramers-Kronig relation, which may comprise a step of generating a scattering field using a Fourier transform on an incident field of an X-ray pulse using a zone plate, a step of halving the scattering field through a cutoff filter to establish a space-domain Kramers-Kronig relation, and obtaining a quantitative real part refractive index tomogram from the other half of the scattering fields using a detector.

### BACKGROUND

The present disclosure relates to a method and a system for full-field quantitative X-ray phase nanotomography using a space-domain Kramers-Kronig (KK) relation.

### BACKGROUND OF THE INVENTION

X-ray nanotomography is a unique imaging tool that observes the three-dimensional structure of sub-millimeter-sized samples at nanometer-scale resolution. The internal nanostructures of the sample may be visualized non-destructively, which is a characteristic advantage over electron microscopy. However, a high X-ray transmission is also linked to a weak X-ray absorption of the material. Various materials show similar attenuation coefficients (μ) and are often indistinguishable by mere transfer (e^{-μd}) measurements alone, especially when the feature size (d) is in nanometers. This problem is further exacerbated at high quantum energies above the absorption band of the material.

To further improve contrast in X-ray imaging, X-ray phase shift has emerged as a new source of contrast. Phase shifts usually provide a clearer contrast than absorption unless the quantum energy is at the boundary of absorption. Various X-ray phase tomography techniques have been introduced, including interferometer-based, grating-based, propagation-based, speckle-based, and Zernike phase contrast (ZPC). Unfortunately, only some phase tomography techniques are currently limitedly applied to nanotomography with detector pixels in micrometers.

One of the popular nanotomography configurations is to introduce the idea of ZPC into transmission X-ray microscopy (TXM). The phase shift may be visualized by placing a phase plate (or ring) near the focal plane of the lens. However, despite the enhancement of sharp contrast, the ZPC technique may not provide a sample phase shift without using a single material approximation or undergoing multiple phase-shift measurements. Instead, it gives mixed results of absorption and phase change, which may not be separated unless both effects are sufficiently weak. Therefore, unlike conventional absorption-controlled nanotomography, sample tomography may not be interpreted as a physical quantity of the sample. These ambiguous results are a major drawback of ZPC nanotomography and hinder quantitative analysis of the sample.

Another popular approach is holotomography. In a nanotomography configuration, the magnification of the sample is through a divergent illumination beam and sufficient propagation after passing through the sample. The phase value is obtained by calculating an unfocused image obtained from three to four different distances through a correlation transfer function (CTF) analysis. However, the phase values obtained are often far from physical phase shifts, since CTF-based phase acquisition is also based on weak absorption and slowly varying phase approximations.

Quantitative X-ray phase nanotomography has recently been done using ptychography. The quantitative real part refractive index of the sample was implemented in three dimensions (3-D) and interpreted as the density of electrons. Ptychographic tomography clearly shows the potential of quantitative X-ray phase nanotomography in several applications. However, the scanning values of the far-field diffraction pattern according to each rotation angle usually require a considerable acquisition time to make one tomogram. For example, using 245 scanning points per projection at 1200 angles requires 20 hours of measurement, excluding phase acquisition and tomogram reconstruction time. Not only does this result in low work throughput, but maintaining stability in nanometers throughout the day is also challenging for modern synchrotron facilities.

### SUMMARY

### Technical Problem

The present disclosure provides a method and a system for full-field quantitative X-ray phase nanotomography using a space-domain Kramers-Kronig (KK) relation.

### Technical Solution

In the present disclosure, a computer system for full-field quantitative X-ray phase nanotomography using a space-domain Kramers-Kronig (KK) relation may include a zone plate configured to generate scattering fields using a Fourier transform on an incident field of an X-ray pulse, a cutoff filter configured to cut off half of the scattering fields to establish a space-domain Klamers-Kronich (KK) relation, and a detector configured to obtain a quantitative real part refractive index tomogram from the other half of the scattering fields.

In the present disclosure, a method for full-field quantitative X-ray phase nanotomography through a space-domain Kramers-Kronig (KK) relation may include a step of generating scattering fields through a Fourier transform on an incident field of an X-ray pulse through a zone plate, a step of cutting out half of the scattering fields through a cutoff filter to establish a space-domain Klamers-Kronich (KK) relation, and a step of obtaining a quantitative real part refractive index tomogram from the other half of the scattering fields through a detector.

### Advantageous Effects

According to the present disclosure, full-field quantitative X-ray phase nanotomography is possible by calculating X-ray quantitative phases directly from measured intensity images without additional requirements through a space-domain Kramers-Kronig (KK) relation. In this case, the present disclosure may establish a Kramers-Kronig (KK) relation in a space-domain by using a cutoff filter. Thus, the present disclosure is highly advantageous in terms of set stability and tomogram acquisition time, without mechanically moving the sample.

### BRIEF DESCRIPTION OF THE DRAWINGS

FIG. 1 is a diagram illustrating Kramers-Kronig (KK) nanotomography according to the present disclosure.

FIG. 2 is a diagram illustrating an experimental configuration of KK nanotomography according to the present disclosure.

FIG. 3 is a diagram illustrating a result of KK nanotomography according to the present disclosure.

FIG. 4 is a diagram for comparison of KK nanotomography and ZPC nanotomography according to the present disclosure.

FIG. 5 is a diagram illustrating a computer system for KK nanotomography according to the present disclosure.

FIG. 6 is a diagram illustrating a method of a computer system for KK nanotomography according to the present disclosure.

### DETAILED DESCRIPTION

Various embodiments of the present disclosure are described below with reference to the accompanying drawings.

In the following, in order to solve various problems associated with quantitative X-ray phase nanotomography, the present disclosure introduces Kramers-Kronig (KK) nanotomography. In this study, quantitative phases were obtained directly from intensity images measured without sample approximation or sample scanning. The present disclosure used the space-domain KK relation instead by applying a cut-off filter to the existing TXM. Based on theory, quantitative real part refractive index tomographys of various samples could be successfully obtained without adding additional mechanically moving parts.

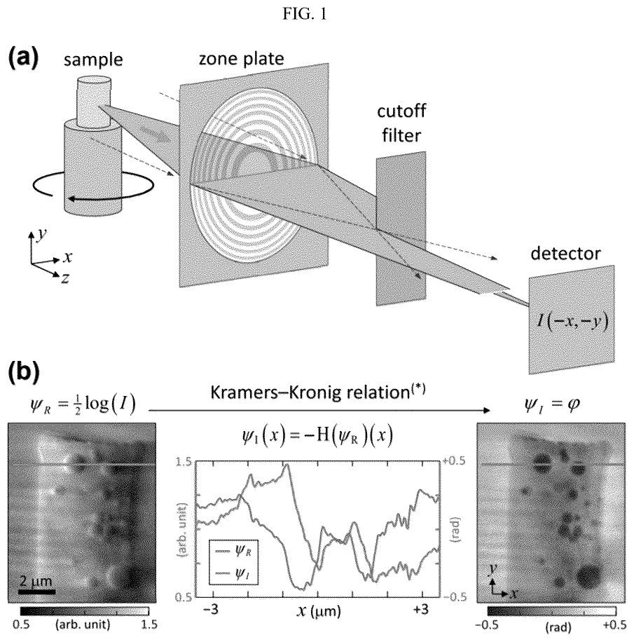

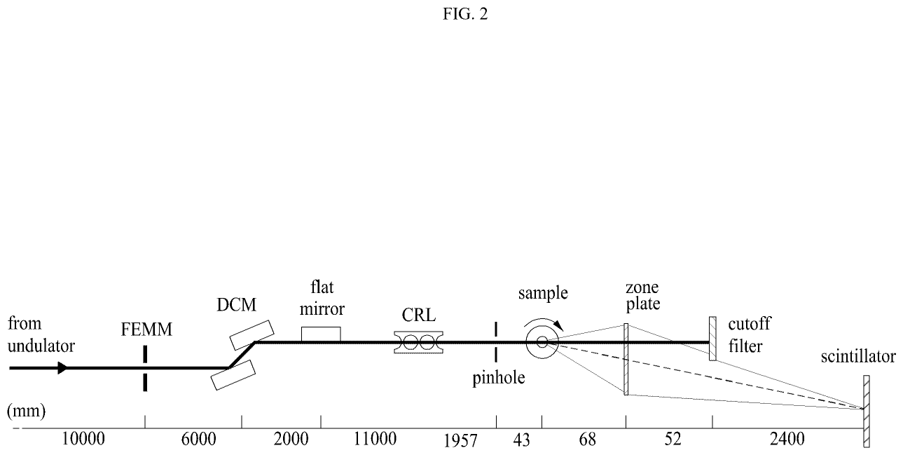

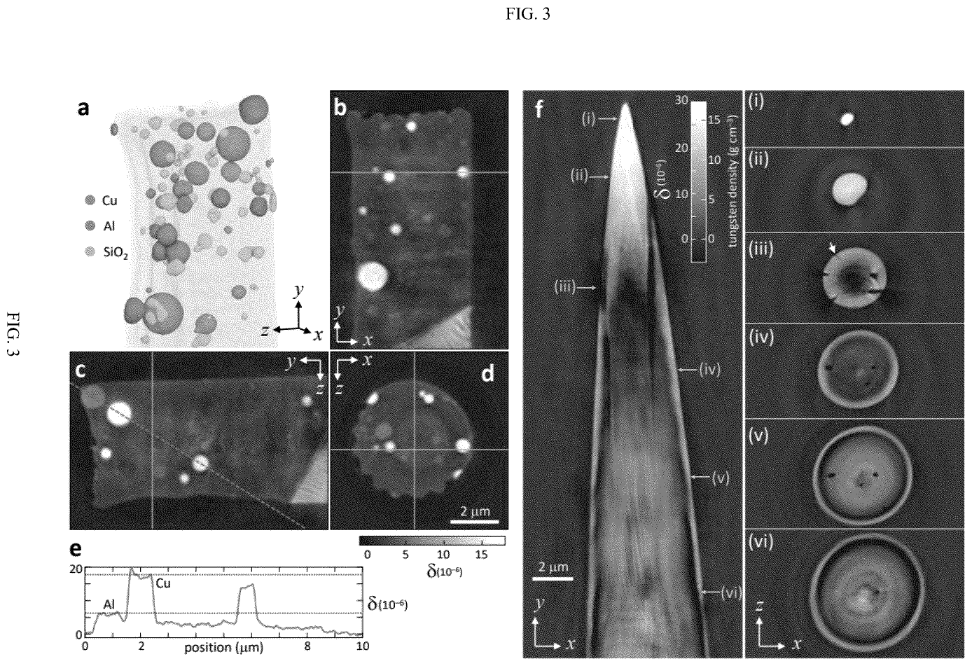

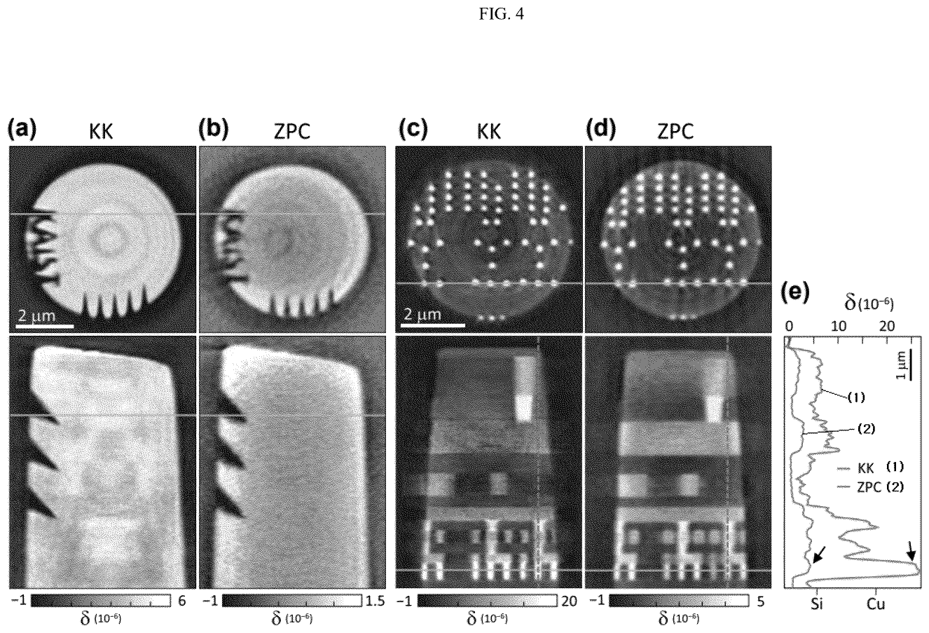

FIG. 1 is a diagram illustrating Kramers-Kronig (KK) nanotomography according to the present disclosure. FIG. 2 is a diagram illustrating an experimental configuration of KK nanotomography according to the present disclosure. FIG. 3 is a diagram illustrating a result of KK nanotomography according to the present disclosure. FIG. 4 is a diagram for comparison of KK nanotomography and ZPC nanotomography according to the present disclosure.

### 1. Principle

### KK Relation of Space-Domain

A complex function at the position x is denoted by φ(x), and a KK relation in a space-domain is as follows.

$${ψ}_{1} ( x ) = H ( {ψ}_{R} ) ( x ) \qquad [ Equation 1 ]$$

where Ψ_{R} and Ψ_{I} rare the real and imaginary parts of Ψ(x), respectively, and H(f)(x) is the Hilbert transform of f(x). This is the space-domain KK relation that connects the real part Ψ_{R} and the imaginary part Ψ_{I} of the space function Ψ(x). This should not be confused with the previously used (frequency-domain) KK relation linking the real and imaginary parts sensitivities (or refractive indexes) of the material.

The real-imaginary parts relation may be translated into an amplitude-phase relation using a logarithm. Substituting Ψ=log U in Equation 1 U(x)=\sqrt{I}e^{iφ} wherein:

$${ψ}_{R} = \frac{1}{2} log I$$

and ψ_{I}=φ may be obtained. Therefore, if U(x) is considered as the sample field, the Equation 1 may obtain a single solution of a phase value φ(x) directly from the measured intensity I(x), which is also a common goal of various phase acquisition methods.

### Role of Cutoff Filter

It should be noted that the KK relation formula is not a universal equation. The relation formula holds only for the interpretation signal, by definition, when it does not have a negative frequency part. Thus, the Equation 1 may be expressed as if, and only as its Fourier function. \tilde{ψ}(u) is 0 for u<0, where u denotes the corresponding spatial frequency. This is similar to the frequency-domain KK relation, which may not have a negative time portion based on the causality of the physical response function.

In this study, we achieved analyticity with the space-domain through the introduction of a cutoff filter ((a) of FIG. 1). The filter was installed near the back-focal plane of a zone plate where the Fourier transform of the sample field was presented. By cutting out half of the sample Fourier plane (u>0 in (a) of FIG. 1), it was possible to confirm the securing of phase information by using the analytical properties of the transferred sample field U and the Equation 1 ((b) of FIG. 1). At this time, the analyticity of its log Ψ=log U may be derived from the analyticality of U based on the first-order born approximation. Therefore, using the space-domain KK relation (Equation 1) by introducing a cutoff filter is the idea of phase acquisition in this study. This should not be confused with the Hilbert-transform based filtering technique of filtered backprojection (FBP), which is related to tomogram reconstruction of scanned images rather than phase acquisition of each scanned image.

The cutoff technique of the present disclosure is more similar to the idea of pupil modulation in electron microscopy and optical microscopy than interferometry-based, oblique-illumination-based, and diffraction-based methods in optical microscopy. The present disclosure excludes illumination-based because it is inefficient for non-diffracted light, such as X-rays. It is also noteworthy that the introduction of a cut-off filter in the back-focal plane is similar to a Foucault knife-edge scanning system. In spite of the similarities in the setup of the optical elements, the present disclosure has no moving machine parts except for the part for the sample rotation, while the existing approach requires scanning the cutoff filter sideways in order to calculate the rate of change of phase.

### Intensity Modulation Function of Cutoff Filter

As described in FIG. 1, when extracting φ(x) from I(x), this means that the cutoff filter somehow allowed the sample phase to adjust the intensity. So, what is the transformation equation between phase and intensity in the current system? This is a very important question for intuitive understanding of a KK relation-based phase restoration method and estimation of the phase-sensitivity of KK nanotomography.

To answer the question, the present disclosure analytically calculated the transformation equation under weak absorption conditions and phase shift conditions similar to ZPC.

$$I ( x ) \approx 1 + log A ( x ) + H ( Φ ) ( x ) \qquad [ Equation 2 ]$$

Here, A(x) and Φ(x) are the amplitude and phase shift images of the sample, respectively. Note that Φ(x) is the original sample phase before the cutoff filter, and this should not be confused with the phase φ(x) of the transmitted sample field after passing through the cutoff filter. The present disclosure has found that the cutoff filter visualizes the Hilbert transform of Φ(x) and always produces an intensity variation comparable to the sample phase variation due to the energy conservation properties of the Fourier transform.

### 2. Experimental Details

### Configuration

A experimental configuration of KK nanotomography is similar to that of the already existing TXM. Advantageously, the configuration consists of simply replacing a phase plate of a ZPC with a cutoff filter in an X-ray nanoimaging (7C XNI) beamline of a Pohang Light Source II (PLS-II) (FIG. 2). An off-axis zone plate imaging scheme was used to eliminate the zero-dimensional beam of the zone plate.

An undulator source optimized for 9.344 keV was used. The laterally and longitudinally adjustable slits were used to adjust the size of the source, which is closely related to the coherence length of the initial beam at the face of the sample. The present disclosure opens a 40 (H)×100 (V) μm² aperture, which only reduces the transverse size of the source, which is originally 500 (H)×50 (V) μm² in size. A silicon 111 double-crystal monochromator (DCM) (Vactron Co., Ltd., Republic of Korea) cooled with liquid nitrogen was used to determine the temporary coherence. Planar glass was introduced to eliminate harmonic frequencies.

A compound refractive lens (CRL) was used to focus the optical element; It consists of three beryllium lenses (RXOPTICS GmbH, Germany) with a curved radius of 0.05 mm. A 100 um sized pinhole was placed in front of the sample to minimize unwanted diffraction noise. The sample was placed on an elaborate rotation stage (RT150U; LABMotion Systems). A 300 μm zone plate with an outermost area width of 30 nm made of 700 nm thick gold (Applied Nanotools Inc., mayada) was used. The zone plate was set 45 μm away from the axis to avoid zero order beams. A cutoff filter is 1 mm wide silicon (0.5 mm thick) attached to an aluminum backing. The flat surface of the filter was used as a cut-off boundary by adjusting the beam direction and width in parallel. The calculated transmission of 1 mm thick silicon for X-ray energy (9.344 keV) was 0.011%.

Tb: LSO scintillator (Tb³⁺: Lu₂SiO₅, 17.0 μm thick, λ_{SC}=542 nm), placed on a YSO plate (Yb₂SiO₅170 μm thick), was used as X-ray detector. An optical microscope equipped with an ×20 objective (NA D 0.4, LD Plan-Neofluar, ZEISS) was used to magnify the scintillator. An sCMOS camera (6.5 μm, 2048×2048, Zyla 4.2 PLUS, Oxford Instruments plc) was used as the detector. Since 2×2 bundled pixels were used, the effective pixel size of the camera is 13.0 μm. The magnification of the X-ray imaging system was adjusted using a resolution target. The corresponding pixel size of the sample image is 36 nm. Since we did not change the sampling rate in the tomographic reconstruction step, the voxel size of the tomograms is 36×36×36 nm² throughout the study.

### 360 Degrees Angle Scan

Unlike conventional tomography, a full 360 degree angular scan is an essential requirement in KK nanotomography. This means that the projections of θ and θ+180° no longer coincide, but instead exist as conjugate pairs to obtain the other half of the Fourier plane. Therefore, although the present disclosure obtained the filtered field image with a single measurement, the completed field image may be obtained by combining the two field images into one. The two-shot condition is a clear practical advantage of KK nanotomography compared to conventional phased nanotomography, which usually requires three or more shots. Furthermore, since KK nanotomography does not require mechanical movement of the sample as before, significantly practical advantages are expected, especially in terms of setup stability and the time taken to acquire the tomogram.

When δθ is the longitudinal imaging resolution and when W is the width of the sample, the angle scanning step (δθ) is defined by δθ=2δx/W. In the present disclosure observed that δθ=2.2° at W=5 μm and =100 nm. A 360 degree angular scan was made through a 1 degree angular step. The number of projections is 361. This disclosure used another angle-scan technique; odd projections were measured first, and even projections were measured later. This method introduced a temporary void space between orthogonal projection angles and helped correct for long-term variations in subsequent phase acquisition and imaging processing steps. The acquisition time for each projection was 2 seconds, 12 minutes for the acquisition of the tomogram, and ˜25 minutes for the total collection (including the sample rotation time between each acquisition). After each scan and phase acquisition, we used the FBP technique to make a tomogram of the sample.

### 3. Results and Discussion

### Tomography Results

To confirm the quantitative performance of KK nanotomography, we prepared samples by mixing three different nanoparticles (silica, aluminum, and copper) with commercially available adhesives. Reconstructed tomograms of the samples are shown in FIGS. 3(a) to (d). The spatial distribution of the δ values is shown, where the refractive index of the X-rays is n=1−δ+iβ. The three-dimensional structure of the sample was effectively visualized, including the nanoparticle embedded with adhesive medium. To distinguish the nanoparticles, we compared the δ values with those of known materials ((e) of FIG. 3, dotted line). Using the density values provided by the manufacturer, we determined the predicted δ values of 5.75, 6.26, and 17.72 for silica, aluminum, and copper, respectively (10⁻⁶ units). As shown in (e) of FIG. 3, the measured value is consistent with the expected value. The mean (general distribution) δ values for aluminum and copper nanoparticles are 6.08 (0.44) and 17.39 (0.86) in 10⁻⁶ units. Some copper particles showed smaller δ values (down to 15×10⁻⁶), which may suggest a density difference within the nanoparticle.

Although copper is easily distinguished by high δ values, quantitatively distinguishing between silica and aluminum is not intuitive because their δ value difference (0.51×10⁻⁶) is comparable to the background δ value (0.38×10⁻⁶). Silica and aluminium nanoparticles are instead distinguished on the basis of their size as indicated in (a) of FIG. 3.

In our measurements, a background level is highly dependent on unwanted correlated diffraction (in other words, correlated noise) coming from the dust on the window or the zone plate. Ideally, such correlated noise should be removed during initial image segmentation (or normalization), or a background level should rely solely on shot noise or readout noise. However, due to the instability of the actual imaging system, it often changes with time and contributes to background noise. Note that this is a common problem that occurs in computerized tomography and is a major cause of ring structure. Fortunately, we have found that the KK-relation based field recovery (Equation 1) of the present disclosure is robust even in noisy environments because of the spectrum-conserving transfer function of the Hilbert transform.

Commercially available tungsten tips (460-106, Ted Pella, Inc., United States) were used for the samples ((f) of FIG. 3). Since the sample was made of one material, we converted the measured δ value to a tungsten density value. The measured density value was close to the single crystal density of tungsten at the top (19.3 g cm⁻³), and gradually decreased as the height decreased. Uneven internals could also be observed, with long narrow tunnels made along the direction of the height. δ values may frequently electron density (ρₑ) through δ=rₑλ²ρₑ/(2π), where the rₑ is the classical electron radius, and λ is the length of the wavelength of the X-ray. This conversion is possible when the quantum energy is sufficiently far from the absorption band of the material.

The spatial resolution of the current demonstration is mainly limited by the flux. This depends on the diffractive power of the sample, the number of injected quanta, and the overall quantum detectability of the x-ray imaging system. The resolution obtained may lead to better than 100 nm based on the fine cracks that harden well of the tungsten tip. In general, the theoretical resolution limit may be calculated from the imaginary part geometry and is expected to be asymmetric: 28 nm in the transverse plane (x-z) and ˜30 nm along the longitudinal plane (y). Transverse resolution enhancement is expected due to the off-axis structure, which in turn collects higher angle diffraction signals. We expect that further optimization of coherent quantization, diffraction, and detection will allow us to get closer to the theoretical resolution limit.

### Comparison With ZPC Nanotomography

We directly compared the KK and ZPC nanotomography techniques by observing the same sample using both methods. For the setting of ZPC, we used the basic XNI setting of the beamline. The same X-ray energy (9.344 keV), focusing optics (CRL), and zone plate placed in off-axis space were used. The phase plate was applied to the unmodulated term of the first order diffraction (u=0). The phase plate has a structure in which a needle hole having a diameter of 4 um is drilled in a gold film having a thickness of 960 nm. This includes a −π/2 phase modulation (at 9.344 keV) in the sample-modulation term, which is similar to a +π/2 relative phase modulation in the non-modulation term. The 360 degree angle scan was made through a 1 degree angle step. The number of projections is 361. The phase of ZPC is based on weak absorption and translation under the phase shift approximation φ(x)=(I(x)−1)/2).

Comparative results for silicon with patterns placed thereon are shown in FIGS. 4(a) and (b). Since the sample consists of pure silicon single crystals 100, it was expected to show a uniform δ value. Although the constant variation will be due to the ring structures not removed ((a) of FIG. 4). On the other hand, the ZPC tomogram does not reveal the exact internal structure due to the halo structure and the shade-off structure ((b) of FIG. 4). These structures are derived from the physical size of the phase plate, which also modulates the low frequency region of the scattered sample field. These structures make ZPC less sensitive to slowly varying structures, as indicated in (b) of FIG. 4, which are important for quantitative analysis. Although structures may be minimized by reducing the size of the phase plate, they remain an unresolved problem as it is difficult to make and maintain nanostructures with substantially such high-aspect ratios.

Comparative results of a integrated circuit are shown in FIGS. 4(c) and (d). In both KK and ZPC results, the internal three-dimensional structure of the circuit was effectively visualized, although the ZPC consistently showed low δ values. In the KK tomography, quantitative discrimination between various constituent materials was possible ((c) of FIG. 4). Among other things, high δ values have provided useful information that allows for the exclusion of substances that do not reach that δ value. For example, the smallest pin structure in the circuit showed a signifimaytly larger δ value compared to the δ values of the other circuit structures ((e) of FIG. 4, red line). Since the measured δ value is much larger than the expected δ value for single crystal structure copper, we may conclude that the smallest and finest structures are made of a material with a higher atomic number ((e) of FIG. 4, arrows). Based on previous studies of integrated circuits, we estimated that the structure was made of tungsten. However, the ZPC tomography results did not quantitatively distinguish the thinnest structures from those of other circuits ((e) of FIG. 4, arrows). This indistinguishability is a common underlying weakness of the ZPC. Unfortunately, some ghost structures were observed in the sample (FIG. 4(e), arrows). The ghost structures were created due to phase recovery failure at some projection angles, including circuit structures parallel to the direction of the beam. Strong absorption and phase shift due to the parallel structures may violate the first-order Born approximation, which is necessary to achieve the analyticity of log U.

### Potential Problems

In order to maintain the intuitive and fast production of KK nanotomography elsewhere, we should address potential problems that may be fundamentally, or substantially, interfering with utilization.

First, we acquired phase only through the transverse direction (x-direction in (a) of FIG. 1). Therefore, the phases between the transverse lines should be based on the well-known background of the observed image. This may be problematic when the sample fully occupies the viewing angle. In order to directly implement a two-dimensional phase map, it is necessary to prepare a cutoff mask that satisfies two-dimensional analyticity. However, we have found that a one-dimensional analysis power alone is sufficient because a background region is already required in the fabrication of phase tomogram to determine the phase between projection angles.

Second, a sufficiently stable beam illumination is needed during acquisition. In KK nanotomography, the position of the cutoff filter is important for accurate phase quantification. In order to achieve analytical power of the sample field U, the cutoff filter should block u>0 or u<0 of the Fourier plane of the sample. However, in order to improve the analytical power of log U, the initial field (u=0) should not be blocked. Fortunately, putting the filter in the correct position is not difficult because the adjustment procedure is almost similar to a fuco knife-edge inspection. However, such strict requirements on the filter position may be problematic when a deviation of the beam illumination angle occurs in the angle-scanning step.

Third, the proposed technique requires full spatial coherence of the sample. Although similarity may be achieved through sufficient spatial filtering or beam expansion, this often reduces the flux of the beam. Since the flux of the beam directly affects the resolution and quality of the tomogram, the determination of a sufficient correlation length presents an important practical problem. In this study, we prepared a ˜5 μm wide sample, which is sufficiently smaller than the calculated lateral correlation length (˜10 μm) for a given setup. Thus, we expect KK nanotomography to be more robust with upcoming diffraction-limited storage rings.

### 4. Conclusions

We have proposed and tested a new quantitative X-ray phase nanotomography that exploits the KK relation in the space-domain. By introducing a cutoff filter into the existing TXM structure, we have shown that the transmitted phase map may be calculated from a single intensity image. Since KK nanotomography requires only two values (θ and θ+180° projection) for phase acquisitions without mechanical variation of the sample, we expect it to be very advantageous in terms of setup stability and tomographic acquisition time compared to conventional phase nanotomography techniques.

Phase quantification capability has been demonstrated in a variety of samples. The constituent material ratio and the constituent density were confirmed by the measured δ. We expect the δ quantification capability to be beneficial in the study of compatible materials such as lithium ion battery materials. To proceed with further studies, it appears that X-ray energy scanning may also be incorporated into KK nanotomography. Taking advantage of the colorless features of the cutoff filter, quantitative phase tomograms may be obtained at various X-ray energies without significant change in settings. Spectral analysis of this three-dimensional distribution of δ values will provide useful information of the composition and state of the sample.

Hereinafter, a method and a system for full-field quantitative X-ray phase nanotomography using the space-domain Kramers-Kronig (KK) relation described above is described.

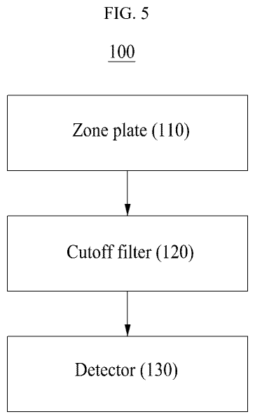

FIG. 5 is a diagram illustrating a computer system for KK nanotomography according to the present disclosure.

Referring to FIG. 5, a computer system 100 may include an zone plate 110, a cutoff filter 120, and a detector 130. The zone plate 110 may generate a scattering field through a Fourier transform on an incident field of an X-ray pulse. The cutoff filter 120 may cut out half of the scattering field to establish a space-domain Kramers-Kronig (KK) relation. The detector 130 may obtain a quantitative real part refractive index tomogram from the other half of the scattering field. In this manner, the detector 130 may obtain a tomogram by obtaining two field images respectively corresponding to projections in two directions orthogonal to each other with respect to the sample, and summing the field images.

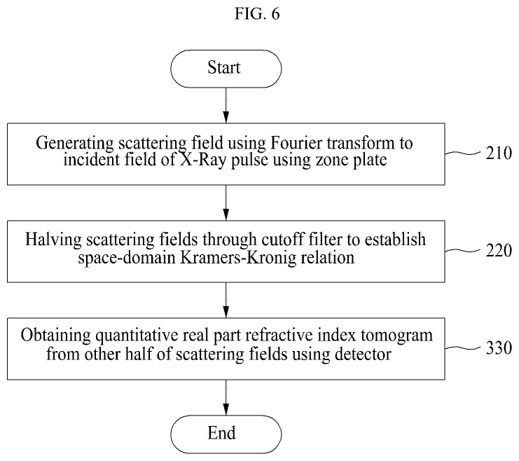

FIG. 6 is a diagram illustrating a method of a computer system for KK nanotomography according to the present disclosure.

Referring to FIG. 6, in a step 210, the zone plate 110 may generate a scattering field by performing a Fourier transform on an incident field of an X-ray pulse. Then, in operation 220, the cutoff filter 120 may cut off half of the scattering field to establish a Kramers-Kronig (KK) relation in the space-domain. The space-domain Kramers-Kronig (KK) relation may be defined as in Equation 3 (same as Equation 1) below to connect the real part and the imaginary part of the space function.

$${ψ}_{1} ( x ) = H ( {ψ}_{R} ) ( x ) \qquad [ Equation 3 ]$$

Here, Ψ_{R}(x) and Ψ_{I}(x) may respectively represent a real part and an imaginary part of Ψ(x), which is a space function representing a complex function at position x, and H(Ψ_{R})(x) may represent a Hilbert transform of Ψ_{R}(x).

Next, in a step 230, the detector 130 may obtain a quantitative real part refractive index tomography from the other half of the scattering field. At this time, the detector 130 may be configured to measure the intensity from the other half of the scattering field, and change the relation between the real part and the imaginary part to the amplitude-phase relation through a logarithm, thereby obtaining a single solution of the phase value from the measured intensity. Specifically, the detector 130 may be configured to obtain φ(x) as the phase value from the measured intensity in such a way that Ψ_{R}(x)=½(log I(x)) and Ψ_{I}(x)=φ(x) are obtained by substituting Ψ(x)=log U(x) when the measured intensity is defined as I(x) and the incident field is defined as U(x). In this manner, the detector 130 obtains two field images respectively corresponding to projections in two directions orthogonal to each other with respect to the sample, and may obtain a tomogram by combining the field images.

According to the present disclosure, full-field quantitative X-ray phase nanotomography is possible by calculating X-ray quantitative phases directly from measured intensity images without additional requirements through the space-domain Kramers-Kronig (KK) relation. In this case, the present disclosure may establish a Kramers-Kronig (KK) relation in a space-domain by using a cutoff filter. Thus, the present disclosure is highly advantageous in terms of set stability and tomographic acquisition time, without mechanically moving the sample.

It is to be understood that the various embodiments of this document, and the terminology used therein, are not intended to limit the technology described herein to particular embodiments, but are to encompass various modifications, equivalents, and/or alternatives of those embodiments. In connection with the description of the figures, like reference numerals may be used for like components. The singular forms “a,” “an,” and “the” may include the plural forms as well, unless the context clearly indicates otherwise. In this document, expressions such as “A or B”, “at least one of A and/or B”, “A, B, or C” or “at least one A, B, and/or C” may include all possible combinations of the listed items together. Expressions such as “first”, “second”, “firstly”, or “secondly” may modify the corresponding components regardless of order or importance, and are only used to distinguish one component from another component and do not limit the corresponding components. When an element is referred to as being “(physically or functionally) connected” or “accessed” to another element, the element may be directly connected to the other element or connected through another element, e.g., a third element.

According to various embodiments, each component of the described components may include one or more entities. According to various embodiments, one or more components or operations of those components described above may be omitted, or one or more other components or operations may be added. Alternatively or additionally, a plurality of components may be integrated into one component. In such a case, the integrated component may perform one or more functions of each of the plurality of components the same as or similar to those performed by that component of the plurality of component prior to integration.

What is claimed is:

1. A computer system for full-field quantitative X-ray phase nanotomography using a space-domain Kramers-Kronig relation, comprising:
a zone plate configured to generate scattering fields through a Fourier transform on an incident field of an X-ray pulse;
a cutoff filter configured to cut off half of the scattering fields to establish a space-domain Kramers-Kronig relation; and
a detector configured to obtain a quantitative real part refractive index tomogram from the other half of the scattering fields.

2. The computer system of claim 1,
wherein the space-domain Kramers-Kronig relation is defined by the following equation,
ψ_{I}(x)=H(ψ_{R})(x)
where the Ψ_{R}(X) and Ψ_{I}(x) represent the real and imaginary parts, respectively, of Ψ(x), which is a space function representing a complex function at position x, and the H(Ψ_{R})(x) represents the Hilbert transform of Ψ_{R}(x),
and connects the real part and the imaginary part of the space function.

3. The computer system of claim 2,
wherein the detector is configured to
measure an intensity from the remaining half of the scattering field, and
obtain a single solution of a phase value from the measured intensity by changing the relation between the real and imaginary parts into an amplitude-phase relation through a logarithm.

4. The computer system of claim 3,
wherein the detector is configured to obtain φ(x) as the phase value from the measured intensity in such a way that Ψ_{R}(x)=½(log I(x)) and Ψ_{I}(x)=φ(x) are obtained by substituting Ψ(x)=log U(x) when the measured intensity is defined as I(x) and the incident field is defined as U(x).

5. The computer system of claim 1,
wherein the detector is configured to
obtain two field images respectively corresponding to projections in two directions orthogonal to each other on the sample, and
obtain the tomogram by combining the field images.

6. A method of full-field quantitative X-ray phase nanotomography using a space-domain Kramers-Kronig relation, comprising:
a step of generating scattering fields through a Fourier transform on an incident field of an X-ray pulse through a zone plate;
a step of halving the scattering fields through a cutoff filter to establish a space-domain Kramers-Kronig relation; and
a step of obtaining a quantitative real part refractive index tomogram from the remaining half of the scattering fields using a detector.

7. The method of claim 6,
wherein the space-domain Kramers-Kronig relation is defined by the following equation,
ψ_{I}(x)=H(ψ_{R})(x)
where the Ψ_{R}(x) and Ψ_{I}(x) represent the real and imaginary parts, respectively, of Ψ(x), which is a space function representing a complex function at position x, and the H(Ψ_{R})(x) represents the Hilbert transform of Ψ_{R}(x),
and connects the real part and the imaginary part of the space function.

8. The method of claim 7,
wherein the step of obtaining a tomogram comprises:
a step of measuring an intensity from the remaining half of the scattering field, and
obtaining a single solution of a phase value from the measured intensity by changing the relation between the real and imaginary parts into an amplitude-phase relation through a logarithm.

9. The method of claim 8,
wherein the step of obtaining a tomogram comprises:
a step of obtaining φ(x) as the phase value from the measured intensity in such a way that Ψ_{R}(x)=½(log I(x)) and Ψ_{I}(x)=φ(x) are obtained by substituting Ψ(x)=log U(x) when the measured intensity is defined as I(x) and the incident field is defined as U(x).

10. The method of claim 6,
wherein the detector obtains two field images respectively corresponding to projections in two directions orthogonal to each other on the sample, and
obtains the tomogram by combining the field images.
